(19) United States
(12) Patent Application Publication
(10) Pub. No.: US 2019/0261627 A1
(43) Pub. Date: Aug. 29, 2019

(54) BIOPOLYMERIC GERMPLASM INTEGUMENTS

(71) Applicant: Aleo BME, Inc., State College, PA (US)

(72) Inventors: John Round, State College, PA (US); Duygu Ercan Oruc, State College, PA (US); Chao Liu, State College, PA (US)

(21) Appl. No.: 16/285,359

(22) Filed: Feb. 26, 2019

Related U.S. Application Data
(60) Provisional application No. 62/635,353, filed on Feb. 26, 2018.

(51) Int. Cl. A01N 25/24; A01N 25/10; C08G 63/685; C05B 17/00

(52) U.S. Cl. CPC A01N 25/24; C05B 17/00; C08G 63/6854; A01N 25/10

(57) ABSTRACT

A germplasm growth inducing composition comprises a biodegradable polymer or oligomer; and a plant bioactive component. The biodegradable polymer can comprise a citrate polymer in some embodiments, the citrate polymer being formed from one or more monomers of citric acid, one or more monomers of a C2-C14 polyol. A method of inducing germplasm growth comprises applying the germplasm growth inducing composition to a plant germplasm as an integument or applying the germplasm growth inducing composition to soil as a soil amendment.

### CROSS-REFERENCE TO RELATED APPLICATIONS

This application claims priority under 35 U.S.C. § 119 to U.S. Provisional Patent Application No. 62/635,353 filed Feb. 26, 2018, the entirety of which is incorporated by reference herein.

### FIELD

The invention is generally related to plant germplasm coatings and soil amendments, and more specifically, to plant germplasm coatings with biodegradable polymers and bioactive plant components capable of influencing germplasm growth, maturation, and stress responses.

### BACKGROUND

Germplasm is living tissue from which new plants can be grown. The type of living tissue can vary, often depending on the type of plant. Exemplary germplasms include a seed or another plant part, such as a leaf, a piece of stem, pollen, or even a few cells of the plant. Given the importance of germplasms in propagating new plants, many different germplasm integuments have been proposed and explored for encouraging germplasm germination. Germplasm integuments are known to provide germplasms with various capabilities and/or benefits. For example, germplasms are often provided with an integument to protect the germplasms from damage during handling, to prevent dust, and to give a cosmetic appearance. Such integuments can also afford the advantages of protecting the germplasms from pests and diseases attack and smoothing the germplasm surface to make planting easier. In order to control the germplasm germination, or the germination rate, plant nutrients or other growth stimulating agents can be incorporated into the germplasm integument. Plant protecting agents, such as pesticides (e.g. fungicides and insecticides), can be incorporated to further protect the germplasm from disease and/or pest attack.

However, while the advantages of integuments are known, application of the integuments has proven to be difficult. For example, most conventional integuments are often difficult to handle, contain non-biodegradable components, contain non-homogenous mixtures, have poor water retention characteristics, and have poor shelf life.

Additionally, most conventional germplasm carriers utilize natural or synthetic soil nettings, woven and other sheet materials as support media for retaining and holding the integument near the germplasm. However, natural soil nettings often are too weak to provide sufficient soil stabilization, have a tendency to tear during application, and are otherwise generally difficult to handle. Synthetic materials, while being more durable, are also more expensive and non-degradable, creating additional problem. For example, when the germplasms germinate and the young germplasms/plants break through the soil and grow upwards, the non-degraded synthetic matting tends to suppress the vegetation growing beneath. The netting can also become dislodged by increased traffic and high winds. Eventually the netting must be manually removed by hand, requiring the netting to being torn apart while in soil. This removal process often has with soil erosion of the topsoil being the unintended result.

Attempts have also been made to eliminate the use of netting by applying germplasm integuments onto the plant germplasm itself in liquid or powdered form. However, this approach has also proved to be unexpectedly challenging. The germplasms must be able to dry satisfactorily after integument and not agglomerate. However, a common problem is that coated germplasms often result in a sticky surface and agglomerate. Coated germplasms that are sticky have serious negative effects on further processing and handling of the germplasms. For example, a coated, sticky germplasm often, for instance, sticks to the wall of the treatment drum, a conveyor belt, or in a container. Also in further processing, the stickiness of the coated germplasm forms additional problems, such as during packaging, storage and/or sowing.

Conventional attempts to overcome the stickiness induced by the germplasm integument have included the application of a powder, such as talc or mica, onto the coated sticky germplasms. However, the application of such powders is often accompanied by severe and undesirable dusting during processing. This not only leads to an unhealthy working environment, but can also cause undesirable deposits on integument machinery, and can in severe cases result in malfunction of the integument machinery. In addition, such dusting can be disadvantageous during sowing.

Accordingly, there is a need for improved germplasm coatings, integuments, and soil amendments.

### SUMMARY

In one aspect, a germplasm growth inducing composition comprises a biodegradable polymer or oligomer; and a plant bioactive component.

In some embodiments, a biodegradable polymer described herein is formed from one or more monomers selected from a group consisting of citric acid, butanediol, octanediol, oxalic acid, lactic acid, pentadecane, ammonia, 3-hexanone, isophorone diisocyanate, 1-hexanol, tridecanal, 1-octen-3-ol, acetaldehyde, butanoic acid, gallic acid, butanoic acid, indole acetic acid, furfural, propanoic acid, glycolic acid, tartaric acid, malic acid, mandelic acid, tannic acid, isocitric acid, aconitic acid, propane-1,2,3-tricarboxylic acid, trimesic acid or any derivative thereof.

In some cases, a biodegradable polymer comprises a citrate polymer. The citrate polymer in some instances is formed from one or more monomers of citric acid and one or more monomers selected from a group consisting of a C2-C14 alcohol, a C2-C14 diol, an isocyanate, glycerol, a polyol, oxalic acid, lactic acid, 1-octen-3-ol, butanoic acid, butanoic acid, indole acetic acid, furfural, propanoic acid, glycolic acid, tartaric acid, malic acid, maleic anhydride, mandelic acid, N-methyldiethanol amine (MDEA), an amino acid, or any combination or derivative thereof. In some cases, the citrate polymer comprises a polyurethane.

In some embodiments, the citrate polymer is formed from one or more monomers of citric acid, one or more monomers of a C2-C14 polyol, and one or more monomers of an amino acid.

A citrate polymer can in some cases have a weight average molecular weight of 300 g/mol or greater.

In some embodiments, a plant bioactive component comprises a phytohormone, a microbial volatile organic compound, a fertilizer, a plant growth-promoting microbe, a germplasm active compound, or any combination thereof.

A phytohormone described herein can in some instances comprise indole acetic acid, lipochitooligosaccharide, a flavonoids, a cytokinin including zeatin, a strigalactone, abscisic acid, a nodulation factor, salicylic acid, jasmonic acid, gibberellic acid, a brassinosteroid, a strigolactone, an auxin, ethylene, a polyamine, nitric oxide, a plant peptide hormone, a karrikin, triacontanol, or any combination or derivative thereof.

A microbial volatile organic compound described herein can comprise in some embodiments γ-patchoulene, 3-methyl butanol, 1-octen 3-ol, 2-undecanone, 3-methylbutanoate, 2-methylbutan-1-ol, 4-methyl-2-heptanone, ethanethioic acid, 2-methyl propanal, ethenyl acetate, 3-methyl 2-pentanoene, methyl 2-methylbutanoate, methyl 3-methylbutanoate, 4-methyl 3-penten-2-one, 3-methyl 2-heptanone, myrcene, terpinene, methyl salicylate, 2-pentadecanone, 1H-pyrrole, ethyl butanoate, chlorobenzene, dimethylsulfone, 2-octanone, 5-dodecanone, 3-methyl-2-pentanone, geosmin, 1-pentanol, 2-methyl-1-propanol, dimethyl 2-octanol, disulfide, acetophenone, 2-isobutyl-3-methoxypyrazine, 2-heptanone, 5-methyl-3-heptanone, 2-methyl-2-butanol, 2-pentanol, 3-octanol, ethanol, anisole, 2-isopropyl-3-methoxypyrazine, hexanol, 2-methylfuran, 3-methyl-1-butanol, 2-pentanone, 3-octanone, 2-ethyl-1-hexanol, 1-butanol, isopropanol, 2-hexanone, 3-methylfuran, 3-methyl-2-butanol, 2-pentylfuran, 1-octen-3-ol, 2-ethylfuran, 2-butanone, isopropyl, 3-hexanone, acetate, isobutyrate, 2-methylisoborneol, isovaleraldehyde, a-terpineol, 2-nonanone, ethylfuran, 2r,3r-butanediol, 2-methyl-1-butanol, citric acid, 1-octanol, a Nod factor, lipochitooligosaccharide, a flavonoid, a strigalactone, or any combination or derivative thereof.

A fertilizer described herein can in some instances comprise a nitrate, potassium, a phosphorous, a phosphate, ammonia, ferric oxide, zinc oxide, an iron chelate, copper oxide, or any combination or derivative thereof.

A plant growth-promoting microbe described herein can comprise Rhizobia, Trichoderma, Streptomyces, Pseudomonas, Glomus, Arbuscular mycorrhiza fungi, Bacillus, Actinomyces, Penicillium, or any combination thereof in some cases.

In some embodiments, a germplasm active compound comprises azoxystrobin, boscalid, carbendazim (MBC), chlorothalonil, cyprodinil, dicloran, fenbuconazole, fludioxonil, metalaxyl, myclobutanil, pyraclostrobin, tebuconazole, thiabendazole, trifloxystrobin, thpi, vinclozolin, pesticides, aldicarb sulfoxide, bifenthrin, chlorpyrifos, coumaphos, a ribonucleic acid sequence, deoxyribonucleic acid sequence, a viral vector, an amino acid, an antibody, an herbicide, a fungicide, atrazine, fluridone, metolachlor, oxyfluorfen, pendimethalin, propazine, tebuthiuron, trifluralin, 2,4 dimethylphenyl formamide (DMPF), acephate, acetamiprid, aldicarb sulfone, citric acid, or any combination or derivative thereof.

In some embodiments, a biodegradable polymer comprises a citrate polymer and the plant bioactive component comprises an ammonium phosphate. In some cases, the citrate polymer has a weight average molecular weight of 300 g/mol or greater, and a ratio of citrate polymer to ammonium phosphate is between 10:1 to 10,000:1 based on a weight of the elemental phosphorous content.

In some embodiments, a germplasm growth inducing composition can further comprise an integument or soil amendment comprising an alginate, polyethylene glycol, peat, pullulan, methyl cellulose, chitosan, polyvinylpyrolidone, starch, or any combination or derivative thereof.

In another aspect, a method of inducing germplasm growth comprises applying a germplasm growth inducing composition described herein to a plant germplasm as an integument. The method can optionally further comprise releasing the plant bioactive component from the composition, wherein releasing the plant bioactive component increases germplasm growth.

In another aspect, a method of inducing germplasm growth comprises applying a germplasm growth inducing composition described herein to soil comprising a germplasm, wherein the plant bioactive material comprises a phosphate containing fertilizer. The method can in some instances further comprise releasing the phosphate containing fertilizer from the composition, wherein releasing the fertilizers increases germplasm grown.

### BRIEF DESCRIPTION OF THE DRAWINGS

FIG. 1 is a graphical illustration of phosphate solubilization by citrate based polymers and alginate/citrate polymer integuments.

FIG. 2 is a graphical illustration of phosphate solubilization by alginate/citrate polymer integument in sand.

FIG. 3 is a graphical illustration of citrate release from a citrate based polymer and alginate/citrate polymer integument.

FIG. 4 is a graphical illustration of phosphate solubilization by standard citrate solution.

FIG. 5 is a graphical illustration showing an effect of temperature on citrate release from a citrate polymer and alginate/citrate polymer coating.

FIG. 6 is a graphical illustration of an effect of initial pH on citrate release from the citrate polymer and alginate/citrate polymer integument.

FIG. 7 is a picture of soybean seeds coated in a fluorescent germplasm growth inducing composition, and control soybean seeds that are uncoated.

FIG. 8A is a picture of a germplasm coated with alginate versus a germplasm coated with alginate/citrate polymer.

FIG. 8B is a picture of an alginate/citrate polymer integument attached to the soybean plant root.

### DETAILED DESCRIPTION

Embodiments described herein can be understood more readily by reference to the following detailed description, examples, and figures. Elements, apparatus, and methods described herein, however, are not limited to the specific embodiments presented in the detailed description, examples, and figures. It should be recognized that these embodiments are merely illustrative of the principles of this disclosure. Numerous modifications and adaptations will be readily apparent to those of skill in the art without departing from the spirit and scope of this disclosure.

In addition, all ranges disclosed herein are to be understood to encompass any and all subranges subsumed therein. For example, a stated range of “1.0 to 10.0” should be considered to include any and all subranges beginning with a minimum value of 1.0 or more and ending with a maximum value of 10.0 or less, e.g., 1.0 to 5.3, or 4.7 to 10.0, or 3.6 to 7.9.

All ranges disclosed herein are also to be considered to include the end points of the range, unless expressly stated otherwise. For example, a range of “between 5 and 10” or “from 5 to 10” or “5-10” should generally be considered to include the end points 5 and 10.

Further, when the phrase “up to” is used in connection with an amount or quantity, it is to be understood that the amount is at least a detectable amount or quantity. For example, a material present in an amount “up to” a specified amount can be present from a detectable amount and up to and including the specified amount.

Unless expressly defined otherwise, all technical and scientific terms used herein have the same meanings as commonly understood by one of with ordinary skilled in the art.

All molecular weights described herein are weight average molecular weights unless expressly stated otherwise.

### I. Compositions

In an aspect, a germplasm growth inducing composition is disclosed here comprising a biodegradable polymer or oligomer; and a plant bioactive component. In some embodiments, a germplasm growth inducing composition is capable of encapsulating or encoating a germplasm in a bioactive film such that the health or behavior of the plant or plant-associated organism is affected. In some embodiments, a germplasm growth inducing composition can be combined with a fertilizer and introduced into soil as a soil amendment, and can affect the health or behavior of a germplasm present in the soil. The health or behavior of a germplasm can, for example, include increasing yield, forming different root structures, change the leaf area, and/or induce greater abiotic or biotic stress tolerance.

For purposes herein, a germplasm include a seed or another plant part, such as a leaf, a piece of stem, pollen, or even a few cells of the plant from which new plants can be grow. Examples of germplasms include maize/corn, soy, rice, wheat, potato, sugarcane, arbuscular mycorrhiza fungi, tomato, lettuce, cabbage, barley, tubers, sorghum, cotton, sugar beets, or any other legumes, fruits, nuts, vegetables, pulses, flowers, or other commercial crop not inconsistent with the objectives of this disclosure. However, these are merely exemplary germplasms, and the list is not meant to be limited only to these germplasms, but can include any germplasm where a germplasm growth inducing composition described herein can positively affect the health or behavior of the germplasm.

In some embodiments, a polymer, oligomer, or elastomer described herein is understood to include at least one multifunctional monomer to create a generally homogeneous 3D cross-linked network structure. A biodegradable polymer, oligomer, or elastomer is generally understood to be a polymeric material that can undergo degradation as a result of the action of microorganisms, enzymes, or hydrolytic cleavage of bonds within the polymeric material over time, such as in days to years.

A biodegradable polymer described herein can have any molecular weight not inconsistent with the objectives of this disclosure. For example, a biodegradable polymer described herein can have an weight average molecular weight of 0.25 kDa, 0.5 kDa, 0.75 kDa, 1 kDa, 2 kDa, 3 kDa, 4 kDa, 5 kDa, 6 kDa, 7 kDa, 8 kDa, 9 kDa, 10 kDa, 20 kDa, 30 kDa, 40 kDa, 50 kDa, 60 kDa, 70 kDa, 80 kDa, 90 kDa, 100 kDa, 120 kDa, 140 kDa, 160 kDa, 180 kDa, 200 kDa, 400 kDa, 600 kDa, 800 kDa, 1000 kDA, 3000 kDa, 5000 kDa, 7000 kDa, 10,000 kDA, 30,000 kDa, 50,000 kDa, 75,000 kDa, 100,000 kDa, 0.25 kDa to 100,000 kDa, 0.5 kDa to 100,000 kDa, 1 kDa to 100,000 kDa, 50 kDa to 100,000 kDa, 100 kDa to 100,000 kDa, 500 kDa to 100,000 kDa, 1,000 kDa to 100,000 kDa, 5,000 kDa to 100,000 kDa, 10,000 kDa to 100,000 kDa, 50,000 kDa to 100,000 kDa, 75,000 kDa to 100,000 kDa, 0.25 kDa to 75,000 kDa, 0.25 kDa to 50,000 kDa, 0.25 kDa to 25,000 kDa, 0.25 kDa to 10,000 kDa, 0.25 kDa to 1,000 kDa, 0.25 kDa to 750 kDa, 0.25 kDa to 500 kDa, 0.25 kDa to 250 kDa, 0.25 kDa to 100 kDa, 0.25 kDa to 50 kDa, 0.25 kDa to 25 kDa, 0.25 kDa to 10 kDa, 0.25 kDa to 1 kDa, or 0.25 kDa to 0.75 kDa.

In some embodiments, a biodegradable polymeric material can degrade over a period of 1, 3, 5, 7, 10, 13, 15, 17, 20, 23, 25, 27, 30, 33, 35, 37, 40, 43, 45, 47, 50, 60, 70, 80, 90, 100, 150, 300, 600, 1 to 600, 5 to 600, 10 to 600, 20 to 600, 30 to 600, 40 to 600, 50 to 600, 60 to 600, 70 to 600, 80 to 600 90 to 600, 100 to 600, 200 to 600, 300 to 600, 400 to 600, 1 to 500, 1 to 400, 1 to 300, 1 to 200, 1 to 100, 1 to 75, 1 to 50, 1 to 40, 1 to 35, 1 to 30, 1 to 25, 1 to 20, 1 to 15, 1 to 10, 1 to 9, 1 to 7, 1 to 5, or 1 to 3 days in agricultural conditions. The biodegradation can occur in response to water absorption, in response to a change in environmental pH, in response to an increase or decrease of temperature, in response to an increase or decrease of the environmental osmolarity, in response to sunlight, any combination thereof, or any response not inconsistent with the objectives of this disclosure.

In some embodiments, a biodegradable polymer described herein can be formed from one or more monomers comprising or selected from a group consisting of citric acid, butanediol, octanediol, oxalic acid, lactic acid, pentadecane, ammonia, 3-hexanone, isophorone diisocyanate, 1-hexanol, tridecanal, 1-octen-3-ol, acetaldehyde, butanoic acid, gallic acid, butanoic acid, indole acetic acid, furfural, propanoic acid, glycolic acid, tartaric acid, malic acid, mandelic acid, tannic acid, isocitric acid, aconitic acid, propane-1,2,3-tricarboxylic acid, trimesic acid, or any combination or derivative thereof. In some instances, a biodegradable polymer is a citrate polymer, catechol-poly(L-aspartic acid)-b-poly(L-phenylalanine), poly(vinyl-N-hexylpyridinium salts), poly(aniline), poly(3-aminophenyl boronic acid-co-3-octylthiophene), chitosan, alginate, hyaluronic acid, starch, poly(3,4-ethylenedioxythiophene), poly(ethylene glycol), poly(ethylene glycol diacrylate), poly(ethyleneimine), poly(ethylene terephthalate), poly(glycolic acid), poly(3-hydroxyalkanoate), poly(hydroxybutyrate)/poly(hydroxyvalerate), poly(3-hydroxybutyrate-co-3-hydroxyvalerate), poly((3-hydroxybutyrate-co-3-hydroxyvalerate)-b-(lactic acid)), poly(3-hydroxyoctanoate), poly(lactic acid), poly(D,L-lactic-co-glycolic acid), poly(L-lactide), poly(methacrylic acid), poly(methyl methacrylate), polyhedral oliogmeric silsequioxane poly(ϵ-caprolactone), polyhedral oligomeric silsesquioxane poly(carbonate-urea) urethane, poly(pyrrole), poly(styrene), poly(styrene)-co-poly(acrylic acid), poly(tetrafluoroethylene), poly(vinyl alcohol), poly(sodium styrene sulfonate), poly(urethane), poly(styrene-block-isobutylene-block-styrene), ultra-high molecular weight poly(ethylene), poly(ϵ-caprolactone), poly(D-lactic acid), poly(D,L-lactide), poly(dimethylsiloxane), or any combination or derivative thereof.

Citric acid, an intermediate in the Krebs cycle, is a multifunctional, nontoxic, readily available, and inexpensive monomer used in the design of diverse biodegradable citrate-based polymers. In a preferred embodiment, a biodegradable polymer described herein comprises a citrate polymer formed from and comprising monomers of citric acid and a mono- or polyfunctional nucleophile. Some particular benefits of citric acid include an ability to participate in pre-polymer formation with poly-functional nucleophiles, such as diol monomers, through a simple, cost-effective, and catalyst-free thermal polycondensation reaction, which enables ester bond formation and facilitates degradation through hydrolysis. During pre-polymer synthesis, pendant carboxyl and hydroxyl chemistry can be partially preserved to provide inherent functionality in the bulk of the material for the conjugation of bioactive molecules. Further, the available pendant carboxyl and hydroxyl chemistries provide the necessary functionality for polymer chain cross-linking in an additional post-polymerization or polycondensation reaction to create a homogeneous cross-linked network of hydrolyzable ester bonds. These bonds allow for polymeric degradation in diverse environments ranging from the human body to agricultural fields.

Furthermore, in some embodiments, a citrate polymer described herein can be modified by incorporating other monomers, such as urethane, to enhance either chemical of mechanical behaviors. Urethane doping is a method to combine the advantages of elastic polyesters with the mechanical strength of polyurethanes. Introducing urethane chemistry into a poly(diol citrate) polyester network can result enhanced physical properties of the citrate polymer, such as improved mechanical strength while maintaining softness and elasticity. In some cases, a citrate polymer described herein can have polyurethane branches or sidechains. In some cases, these polyurethane branches can serve as chain extenders or as crosslinkers. For example, citric acid can be reacted with a polyol in the presence of a controlled amount of isocyanate to form a polyester-based citrate polymer having polyurethane side chains, which can function as chain extenders to increase the molecular weight and/or physical properties of the citrate polymer. In another example, citric acid can be reacted with a polyol in the presence of a controlled amount of diisocyanate to form a polyester-based citrate polymer having polyurethane side chains, which function as crosslinkers due to the presence of two isocyanate groups on the diisocyanate. For instance, a poly(diol citrate) prepolymer described herein can be reacted with a diisocyanate such as hexamethylene diisocyanate, and the hexamethylene diisocyanate can form polyurethane chains extending off the citrate polymer, functionally serving as a chain extender with enhanced hydrogen bonding within the citrate polymer network. Citrate polymer diversity can be further increased using various monomers and chemicals with reactive functional groups, such as hydroxyls.

In some embodiments, a citrate polymer described herein can be formed from one or more monomers of citric acid and one or more monomers selected from a group consisting of a C2-C14 alcohol, a C2-C14 diol, an isocyanate, glycerol, a polyol, oxalic acid, lactic acid, 1-octen-3-ol, butanoic acid, butanoic acid, indole acetic acid, furfural, propanoic acid, glycolic acid, tartaric acid, malic acid, maleic anhydride, mandelic acid, N-methyldiethanol amine (MDEA), an amino acid, or any combination or derivative thereof. In some instances, the citrate polymer is formed from one or more monomers of citric acid, one or more monomers of a C2-C14 polyol, and one or more monomers of an amino acid. Exemplary C2-C14 polyols comprise, ethylene glycol, propylene glycol, a butanediol (such as 1,3-butane diol, 2,3-butanediol, 1,4-butanediol, or any derivative thereof), pentanediol, and the like, including both straight and branched chain isomers.

A citrate polymer described herein can have a weight average molecular weight of 250 g/mol or greater, 275 g/mol or greater, 300 g/mol or greater, 325 g/mol or greater, 350 g/mol or greater, 375 g/mol or greater, 400 g/mol or greater, 250 g/mol to 400 g/mol, 275 g/mol to 400 g/mol, 300 g/mol to 400 g/mol, 325 g/mol to 400 g/mol, 350 g/mol to 400 g/mol, 250 g/mol to 375 g/mol, 250 g/mol to 350 g/mol, 250 g/mol to 325 g/mol, 250 g/mol to 300 g/mol, or 250 g/mol to 275 g/mol.

A plant bioactive component described herein can comprise a phytohormone, a microbial volatile organic compound, a fertilizer, a plant growth-promoting microbe, a germplasm active compound, or any combination thereof. The plant bioactive component can be suspended, entombed, encapsulated, or otherwise mechanically fixed into a biodegradable polymer or oligomer matrix present in a germplasm growth inducing composition described herein. In some embodiments, a plant bioactive component can be covalently bound and/or conjugated to the biodegradable polymer or oligomer, such as on pendant carboxyl, hydroxyl, or amino chemistry partially preserved in the polymer, as previously described.

Phytohormones are biologically active molecules produced in very low concentrations in plants, that regulate a variety of cellular processes in plants, such as plant growth. Phytohormones are generally understood to function as chemical messengers to communicate cellular activities in higher plants. Phytohormones play key roles and coordinate various signal transduction pathways during abiotic-stress response. They regulate external as well as internal stimuli. Some phytohormones, such as abscisic acid (ABA), have been identified as stress hormones. ABA plays critical roles in plant development: maintenance of germplasm dormancy, inhibition of germination, growth regulation, stomatal closure, fruit abscission, besides mediating abiotic and biotic stress responses. In some embodiments, a phytohormone described herein can comprise an indole acetic acid; lipochitooligosaccharide; a flavonoid, a cytokinin, abscisic acid, a nodulation factor, salicylic acid, jasmonic acid, gibberellic acid, a brassinosteroid, a strigolactone, an auxin, ethylene, a polyamine, nitric oxide, a plant peptide hormone, karrikin, triacontanol, or any combination or derivative thereof.

Flavonoids are low molecular weight polyphenolic secondary metabolic compounds universally distributed in green plant kingdom. Flavonoids play a variety of biological activities in plants, animals, and bacteria. In plants, flavonoids have long been known to be synthesized in particular sites and are responsible for color, aroma of flowers, fruit to attract pollinators and subsequent fruit dispersion, germination, growth and development of seedlings. Flavonoids can protect plants from different biotic and abiotic stresses; act as unique UV-filters; and can function as signal molecules, allelopathic compounds, phytoalexins, detoxifying agents, and/or antimicrobial defensive compounds. Flavonoids have even been observed to help provide frost hardiness, drought resistance and may play a functional role in plant heat acclimation and freezing tolerance. In some instances, a germplasm growth inducing composition can enable an immediate or extended release of flavonoids that can affect plants in one or more of these diversity of ways, and in some cases can maintain that effect over a course of a those plants' development.

Flavonoids are classified in six major subgroups: chalcones, flavones, flavonols, flavandiols, anthocyanins, and proanthocyanidins or condensed tannins and a seventh group, the aurones is found in some species. Specific flavonoids that a biodegradable polymer could deliver include luteolin, quercetin, hesperetin, delphinidin, chalconaringenin, ohloretin, kaempferol, apigenin, genistein, daidzein, naringenin, phloretin, and cyaniding, or any combination or derivative thereof. The encapsulating biopolymer's degradation rate, the local environmental factors, and the crop to which it is applied may determine the levels at which each flavonoid factor may be effectively administered.

Cytokinins are a class of phytohormones that promote cell division, or cytokinesis, in plant roots and shoots. They are involved primarily in cell growth and differentiation, but also affect apical dominance, axillary bud growth, and leaf senescence. Exemplary cytokinins include kinetin, zeatin, 6-benzylaminopurine, diphenylurea, and thidiazuron (TDZ).

Strigolactones are a class of phytohormones involved in the signaling pathways, and include as strigol, orobanchol, deoxystrigol, orsorgolactone, or any combination and/or derivative thereof.

A nodulation factor (“nod factor”) is a signaling molecule produced by soil bacteria (Rhizobia) during the intiation of nodules on the root of legumes. Nod factors are believed to induce the expression of certain host plant genes involved in the early phases of nodule initiation and morphogenesis. The onset of nodule development, the result of rhizobia-legume symbioses, is determined by the exchange of chemical compounds between microsymbiont and leguminous host plant. Lipo-chitooligosaccharidic nodulation (Nod) factors, secreted by rhizobia, belong to these signal molecules. Nod factors consist of an acylated chitin oligomeric backbone with various substitutions at the (non)reducing-terminal and/or nonterminal residues. They induce the formation and deformation of root hairs, intra- and extracellular alkalinization, membrane potential depolarization, changes in ion fluxes, early nodulin gene expression, and formation of nodule primordia. Nod factors play a key role during nodule initiation and can have a biological effect at nano- to picomolar concentrations.

A Nod factor described herein can have a generalized structure comprising a backbone of three, four, or five β-1,4-linked N-acetylglucosaminyl residues, N-acylated at the nonreducing-terminal residue by either a “common” fatty acid, such as vaccenic (C18:1) and stearic (C18:0) acid, or by a (poly)unsaturated fatty acid, such as C20:1 (Mesorhizobium loti NZP2213) or C18:4 (R. leguminosarum by viciae A1). in some cases, an N-methyl, 0-acetyl, and O-carbamoyl groups are found at the nonreducing-terminal residue and L-fucosyl, 2-O-Me-fucosyl, 4-O-Ac-fucosyl, acetyl, and sulfate ester at the reducing-terminal residue

An auxin described herein is a class of plant hormones that cause elongation of cells in shoot and root tips, and promote cell division, stem growth, and root growth. Exemplary auxins comprise indole-3-acetic acid, 4-chloroindole-3-acetic acid, phenylacetic acid, indole-3-butyric acid, indole-3-propionic acid, 1-naphthaleneacetic acid, 2,4-dichlorophenoxyacetic acid (2,4-D), and combinations and/or derivatives thereof.

A plant peptide hormone described herein comprises amino acid sequences capable of triggering diverse physiological behavior in plants. It has been demonstrated that peptide signaling plays a greater than anticipated role in various aspects of plant growth and development. A substantial proportion of these peptides are secretory and act as local signals mediating cell-to-cell communication within, and between, plants. Specific receptors for several peptides have been identified as being membrane-localized receptor kinases, the largest family of receptor-like molecules in plants. In some embodiments, germplasm growth inducing compositions described herein comprise one or more plant peptide hormones that can be released proximate to a germplasm and can have induce, accelerate, or otherwise beneficially encourage germination and plant growth. exemplary plant peptide hormones comprise systemin, PSK (phytosulfokine), HypSys (hydroxyproline-rich glycopeptide systemin), Pepl, CLE (CLAVATA3)/TDIF (tracheary element differentiation inhibitory factor), PSY (plant peptide containing sulfated tyrosine), CEP (C-terminally encoded peptide), RGF/CLEL/GLV (root meristem growth factor/CLE-like/GOLVEN), PIP (PAMP-induced peptide), IDA (Influorescences deficient in abcission) CIF (Casparian strip integrity factor) subclasses, or any combination and/or derivative thereof.

In some embodiments, plant peptide hormones can determine a number of cells and a size of tissues, control pollination, and/or help a plant respond to climate change or disease. For example, in some cases Clavata3 (CLV3)/endosperm surrounding region (CLE) signaling peptides can be encoded in large plant gene families and can have broad effects. CLV3 and the other A-type CLE peptides can promote cell differentiation in root and shoot apical meristems and can accelerate plant growth in some cases such that growing seasons can be shortened and provide farmers with an opportunity to “double-crop” on the same land.

A Microbial Volatile Organic compound (“MVOC”) described herein comprises a chemical produced by bacteria that can influence the metabolism of other bacteria, which can indirectly or directly influence the grow of plants. Given the physically separated distribution of bacterial populations (micro-colonies) in the porous soil matrix, MVOCs play key roles in interspecific bacterial interactions. Rhizosphere-inhabiting bacteria are believed to invest a substantial part of the energy obtained from metabolizing root-exudates to produce bioactive MVOCs. Volatiles produced by Collimonas pratensis and Serratia plymuthica have been observed to stimulate the growth of Pseudomonas fluorescens, whereas volatiles emitted by Paenibacillus sp., Pedobacter sp. and the mix of all four bacteria generally do not affect P. fluorescens growth. C. pratensis and S. plymuthica have been observed to produce very high numbers of unique MVOCs, including S-methyl thioacetate, methyl thiocyanate, benzonitrile and DMDS. Specific MVOCs produced by C. pratensis include among others: 3-hexanone, (2-methyl propanal, ethenyl acetate, 3-methyl 2-pentanoene, methyl 2-methylbutanoate, methyl 3-methylbutanoate, 4-methyl 3-penten-2-one, 3-methyl 2-heptanone, myrcene, terpinene, and methyl salicylate. Specific MVOCs produced by S. plymuthica included among others: 2-pentadecanone, 1H-pyrrole, ethyl butanoate, chlorobenzene, dimethylsulfone, 2-octanone, and 5-dodecanone.

In some embodiments, MVOCs exhibit suppressive effects on soil eukaryotes that are harmful to agricultural crops; e.g., plant-pathogenic fungi. For example, rhizobacterial isolates comprising S. plymuthica, S. odorifera, Stenotrophomonas maltophilia, Stenotrophomonas rhizophila, P. fluorescens, and P. trivialis synthesize and emit complex blends of MVOCs that inhibit growth of many phytopathogenic and non-phytopathogenic fungi.

However, while MVOCs exhibit strong biologic effects, application of MVOCs directly onto germplasms or in soil is limited by the efficiency of the MVOCs are reaching their intended biological targets in sufficient quantities and for a biologically effective amount of time, with much of the MVOCs exiting the soil substrate within a day of application. MVOC's quick dispersion rate have prevented them from being utilized in a cost-effective manner in agricultural applications that require chemical interaction for extended periods of time. Further, the cost of MVOC and their synthetic equivalent prevent them from being scaled in an agricultural economic system that is very sensitive to input costs.

In some embodiments, a MVOC described herein includes the soil antibiotic pyrrolnitrin (PRN). PRN is a chlorinated phenylpyrrol antibiotic that was first isolated from Burkholderia pyrrocinia and was later found in other genera, such as Pseudomonas, Enterobacter, Myxococcus, and Serratia. PRN has shown broad-spectrum activity against a range of fungi belonging to the Basidiomycota, Deuteromycota, and Ascomycota, including several economically important phytopathogens such as Rhizoctonia solani, Botrytis cinerea, Verticillium dahliae, and Sclerotinia sclerotiorum. For example, PRN production by Burkholderia cepacia strain 5.5B was related to the suppression of stem rot of poinsettia (Euphorbia pulcherrima) caused by R. solani. PRN has been used as a lead structure in the development of a new phenylpyrrol agricultural fungicide.

In some embodiments, a MVOC described herein comprises PRN, γ-patchoulene, 3-methyl butanol, 1-octen 3-ol, 2-undecanone, 3-methylbutanoate, 2-methylbutan-1-ol, 4-methyl-2-heptanone, ethanethioic acid, 2-methyl propanal, ethenyl acetate, 3-methyl 2-pentanoene, methyl 2-methylbutanoate, methyl 3-methylbutanoate, 4-methyl 3-penten-2-one, 3-methyl 2-heptanone, myrcene, terpinene, methyl salicylate, 2-pentadecanone, 1H-pyrrole, ethyl butanoate, chlorobenzene, dimethylsulfone, 2-octanone, 5-dodecanone, 3-methyl-2-pentanone, geosmin, 1-pentanol, 2-methyl-1-propanol, dimethyl 2-octanol, disulfide, acetophenone, 2-isobutyl-3-methoxypyrazine, 2-heptanone, 5-methyl-3-heptanone, 2-methyl-2-butanol, 2-pentanol, 3-octanol, ethanol, anisole, 2-isopropyl-3-methoxypyrazine, hexanol, 2-methylfuran, 3-methyl-1-butanol, 2-pentanone, 3-octanone, 2-ethyl-1-hexanol, 1-butanol, isopropanol, 2-hexanone, 3-methylfuran, 3-methyl-2-butanol, 2-pentylfuran, 1-octen-3-ol, 2-ethylfuran, 2-butanone, isopropyl, 3-hexanone, acetate, isobutyrate, 2-methylisoborneol, isovaleraldehyde, a-terpineol, 2-nonanone, ethylfuran, 2r,3r-butanediol, 2-methyl-1-butanol, citric acid, 1-octanol, a Nod factor, lipochitooligosaccharide, a flavonoid, a strigalactone, or any combination or derivative thereof.

In some embodiments, a germplasm growth inducing composition comprises an MVOC in which the MVOC comprises 0.1%, 1%, 5%, 10%, 20%, 30%, 40%, 50%, 60%, 70%, 80%, 90%, 99%, or 10% or greater of the average molecular weight of the biodegradable polymer or oligomer. In one embodiment of a germplasm growth inducing composition, the biodegradable, polymeric material comprises a citrate polymer and a microbial volatile organic compound in which the microbial volatile organic compound comprises 0.1%, 1%, 5%, 10%, 20%, 30%, 40%, 50%, 60%, 70%, 80%, 90%, or 99% of the molecular weight of the polymer.

A fertilizer described herein is material that is applied to soils or to plant tissues to supply one or more plant nutrients essential to the growth of plants. In some embodiments, a fertilizer described herein comprises a nitrate, potassium, a phosphorous, a phosphate, ammonia, ferric oxide, zinc oxide, an iron chelate, copper oxide, or any combination or derivative thereof.

Particularly with regards to phosphorus (P), available P content has become a primary nutritional component and a P content increase is labeled according to rising phosphorus analysis or grade. The amount of P in fertilizers is expressed as percentage of phosphorus pentoxide (P₂O₅) of the total volume. Fertilizer terminology defines available P as the sum of water-soluble and citrate-soluble P. The sum of available and citrate-insoluble P constitutes total P. Rock phosphates (i.e. phosphorite) generally has low amounts of available P. There is no water-soluble P in most rock phosphate, and citrate solubility varies from 5% to 17% of total P. Higher analysis, non-ammoniated fertilizers such as tri-superphosphate (TSP) have available P amounts of 97 to 100 percent total P, with 85% and 87% being water-soluble P respectively. Ammoniated phosphate sources, such as diammonium phosphate (DAP) and monoammonium phosphate (MAP), have P availabilities of 100 percent of total P, with up to 95% being water-soluble. Studies by have demonstrated the ability of these higher analysis fertilizers to influence plant growth, particularly that effectiveness of P sources could be attributed to the amount of water-soluble P in the fertilizer source. In the international and US markets, DAP serves as the standard source of phosphorus fertilizer. Today, non-ammoniated P forms are not seen in production agriculture and are typically reserved for specialty markets, with rock phosphate primarily serving the organic farming community and TSP in the turf management industry.

When fertilizer P is added to the soil, like all fertilizers and soil amendments, it faces a plethora of reactions affecting its' activity and fate. Phosphorus is also a unique nutrient in that it is never seen in elemental form and moves very little through the soil profile, unless added to extreme excess. When applied, there are many reactions within the recipient soil caused by chemical (mineralogy, organic matter, pH, interactions with other nutrients), physical (texture, aeration, temperature, moisture) and biological (crop residues, soil fauna) properties of the soil. These reactions include transformation of 1) P as ions and compounds in the soil solution, 2) P adsorbed on the surfaces of inorganic soil constituents, 3) P mineralization, and 4) P integration as a component of soil organic matter. These reactive groups can be described as pools that are sources of P for plant growth. A reasonable understanding of these categories and the soil factors that control the fate of P allows one to make better fertility management decisions. Soil Solution P is the fraction that is taken up by the plant.

Adsorbed P on the surface of inorganic constituents has been referred to as fixed P or more recently has been termed as “labile P.” Labile P consists of solution P compounds, H₂PO₄₋ and HPO₄₋₂, that have left soil solution through chemical reactions and are retained on reactive surfaces in the solid phase of soil. In acidic soils, surfaces include Aluminum (Al) and Iron (Fe) oxide and hydroxide. These minerals have a net positive charge and attract the anionic P compounds readily. These dynamic reactions within the soil have led to the development of novel, efficiency technologies such as the one characterized herein capable of maximizing P availability and sustaining that availability during the life cycle of specific crops.

In some embodiments, a germplasm growth affecting composition can comprise a biodegradable polymer mixed with a fertilizer comprising nitrate, potassium, a phosphorous, a phosphate, ammonia, ferric oxide, zinc oxide, an iron chelate, copper oxide, or any combination or derivative thereof. The biodegradable polymer can be mixed in any ratio with the fertilizer that is not inconsistent with the objectives of this disclosure. For example, in some cases, the biodegradable polymer can be combined with the fertilizer in a 1:1, 1:10, 1:20, 1:30:1:40, 1:50, 1:60, 1:70, 1:80, 1:90 1:100, 1:200, 1:300, 1:400, 1:500, 1:600, 1:700, 1:800, 1:900, 1:1,000, 1:2,000, 1:3,000:1:4,000, 1:5,000, 1:6,000, 1:7,000, 1:8,000, 1:9,000, 1:10,000 or greater ratio. Moreover, in some cases, the fertilizer can be combined with the biodegradable polymer in a 1:1, 1:10, 1:20, 1:30:1:40, 1:50, 1:60, 1:70, 1:80, 1:90 1:100, 1:200, 1:300, 1:400, 1:500, 1:600, 1:700, 1:800, 1:900, 1:1,000, 1:2,000, 1:3,000:1:4,000, 1:5,000, 1:6,000, 1:7,000, 1:8,000, 1:9,000, 1:10,000 or greater ratio.

In some embodiments, a biodegradable polymer described herein can be mixed with liquid diammonium phosphate (DAP) in a 1:10 to 1:1000 ratio by weight based on the P content. In one preferred embodiment, a biodegradable polymer described herein can be mixed with liquid diammonium phosphate (DAP) in a 1:100 ratio by weight based on the P content. In some embodiments, a biodegradable polymer described herein can be mixed with granular monoammonium phosphate (MAP) in a 1:500 to 1:3000 ratio by weight based on its P content. In some embodiments, a biodegradable polymer described herein can be mixed with granular monoammonium phosphate (MAP) in a 1:1000 ratio by weight based on its P content. 14.

In yet other embodiments, a biodegradable polymer comprises a citrate polymer and the plant bioactive component comprises an ammonium phosphate. In some instances, the citrate polymer has a weight average molecular weight of 300 g/mol or greater, and a ratio of citrate polymer to ammonium phosphate is between 10:1 to 10,000:1 based on a weight of the elemental phosphorous content.

A germplasm growth affecting composition comprises a biodegradable polymer mixed with a fertilizer can be applied to a field in some cases by broadcasting the composition, or in other cases, by being mixed in the soil, such as being applied in “bands” near newly planted seeds. As the biodegradable polymer degrades over time, the fertilizer can be slowly released into the soil.

Plant growth-promoting bacteria (PGPB) described herein are soil-based rhizosphere, rhizoplane, and phylosphere bacteria that, under some conditions, are beneficial for plants. While not intending to be bound by theory, PGPB are believed to promote plant growth in two different ways. First, PGPBs can directly affect the metabolism of the plants by providing substances that are usually in short supply. These bacteria are capable of fixing atmospheric nitrogen, of solubilizing phosphorus and iron, and of producing plant hormones, such as auxins, gibberellins, cytokinins, and ethylene. Additionally, PGPB can improve a plant's tolerance to stresses, such as drought, high salinity, metal toxicity, and pesticide load. One or more of these mechanisms can contribute to the increases obtained in plant growth and development that are higher than normal for plants grown under standard cultivation conditions. A second way PGPBs can affect the metabolism and growth of plants is through indirect plant growth promotion of preventing the deleterious effects of phyto-pathogenic microorganisms (bacteria, fungi, and viruses). In this manner, PGCBs can produce substances that harm or inhibit other microbes, but not plants, such as by limiting the availability of iron to pathogens, or altering the metabolism of the host plant to increase its resistance to pathogen infection.

Many soil and especially rhizosphere bacteria can stimulate plant growth in the absence of a major pathogen by directly affecting plant metabolism. These bacteria belong to diverse genera, including Acetobacter, Achromobacter, Anahaena, Arthrobacter, Azoarcos, Azospirillum, Azotobacter, Bacillus, Burkholderia, Clostridium, Enterobacter, Flavobacterium, Frankia, Hydrogenophaga, Kluyvera, Microcoleus, Phyllobacterium, Pseudomonas, Serratia, Staphylococcus, Streptomyces, Vibrio, and Rhizobium, and any bacteria in these genera can be used in a germplasm growth inducing composition described herein. In some embodiments, a germplasm growth inducing composition comprises a plant growth-promoting microbe including Rhizobia, Trichoderma, Streptomyces, Pseudomonas, Glomus, Arbuscular mycorrhiza fungi, Bacillus, Actinomyces, Penicillium, or any combination thereof.

A germplasm active compound described herein is a natural or synthetic compound or molecule that can induce or cause a biological effect in a plant germplasm, such as plant growth, pathogen resistance, or any other effect described herein. In some embodiments, a germplasm active compound described herein comprises azoxystrobin, boscalid, carbendazim (MBC), chlorothalonil, cyprodinil, dicloran, fenbuconazole, fludioxonil, metalaxyl, myclobutanil, pyraclostrobin, tebuconazole, thiabendazole, trifloxystrobin, thpi, vinclozolin, pesticides, aldicarb sulfoxide, bifenthrin, chlorpyrifos, coumaphos, a ribonucleic acid sequence, deoxyribonucleic acid sequence, a viral vector, an amino acid, an antibody, an herbicide, a fungicide, atrazine, fluridone, metolachlor, oxyfluorfen, pendimethalin, propazine, tebuthiuron, trifluralin, 2,4 dimethylphenyl formamide (DMPF), acephate, acetamiprid, aldicarb sulfone, citric acid, or any combination or derivative thereof.

Plants and microbes interact in a myriad of ways in terrestrial ecosystems, which span from molecular to open-field scales. The basis of such communications among and within species is of intense interest among the plant-biotic interactions research community. In particular, plant perceptions of extracellular DNA and extracellular RNA have created an opportunity not only to govern plant immune response, but also affect the various pests and pathogens that impede plant growth in the field. Such genetic materials in plant, insect, and microbe interactions can play a provocative role in self- and non-self-recognition and powerful induction of innate immunity in plants. Nucleic acid structures beyond general DNA and RNA include RNA interference (RNAi), double stranded (dsDNA), small interference RNA (siRNA), and shorthairpin RNA (shRNA). RNAi is a natural process cells use to turn down, or suppress the activity of specific genes and may be applied to plants, insects, and other eukaryotic organisms. RNAi is a highly efficient regulatory process that causes posttranscriptional gene silencing in most eukaryotic cells and represents a promising new approach for producing gene-specific inhibition and knockouts in the field or greenhouse. However, as effective as nucleic acids are in controlling biological processes, nucleic acids are subject to degradation in many environments when exposed to enzymatic nucleases and denaturing stresses. Nucleic acid structure and efficacy can in some instances be preserved by a biomaterial capable of limiting its exposure to the elements, both in the field and in transportation and storage systems. In some embodiments described herein, when a germplasm active compound comprises an RNA or DNA sequence, the RNA or DNA sequence can be encapsulated or embedding with a polymer matrix of the biodegradable polymer, effectively isolating the RNA or DNA from environmental degradation, and, as the biodegradable polymer degrades, the RNA or DNA can be slowly released over time.

In some embodiments, herbicides described herein include aminopyralid, chlorsulfuron, clopyralid, dicamba, diuron, glyphosate, hexazinone, imazapic, imazapyr, methsulfuron methyl, and picloram. Pesticides described herein include aloachlor, aldicarb, atrazine, benzopyrene, carbofuran, chlordane, 2,4-D, dalapon, endrin, ethylene dibromide, heptachlor, hexachlorobenzene, lindane, oxamyl, simazine, and toxaphene. Incorporation of these herbicides and/or pesticieds in a biodegradable polymer described herein can, in some embodiments, enable lower dosing or more accurate and efficient administration to plants when applied directly on germplasms as an integument or to soil as a soil amendment.

In some embodiments, a germplasm growth inducing composition described herein further comprises an integument or soil amendment. An integument or soil amendment can in some instances comprise an alginate, polyethylene glycol, peat, pullulan, methylcellulose, chitosan, polyvinylpyrolidone, starch, or any combination or derivative thereof. The integument or soil amendment can be mixed with a biodegradable polymer described herein, or in some cases can be covalently bound to the biodegradable polymer. An integument or soil amendment can be present in a germplasm growth inducing composition in an amount of 1% to 1000%, 5% to 1000%, 10% to 1000%, 15% to 1000%, 20% to 1000%, 25% to 1000%, 30% to 1000%, 40% to 1000%, 50% to 1000%, 75% to 1000%, 100% to 1000%, 200% to 1000%, 400% to 1000%, 600% to 1000%, 800% to 1000%, 1% to 800%, 1% to 600%, 1% to 400%, 1% to 200%, 1% to 100%, 1% to 75%, 1% to 50%, 1% to 40%, 1% to 30%, 1% to 20%, 1% to 15%, 1% to 10%, 1% to 9%, 1% to 8%, 1% to 7%, 1% to 6%, 1% to 5%, 1% to 4%, 1% to 3%, 1%, 2%, 3%, 4%, 5%, 6%, 7%, 8%, 9%, 10%, 12%, 14%, 16%, 18%, 20%, 25%, 30%, 35%, 40%, 45%, 50%, 55%, 60%, 65%, 70%, 75%, 80%, 85%, 90%, 95%, or 100% based on a weight amount compared to the biodegradable polymer or oligomer.

An alginate is a natural polymer composed of (1,4)-linked β-D-mannuronic acid and α-L-guluronic acid, and includes various synthetic or natural derivatives, including salts thereof such as sodium or potassium. Alginate has a wide variety of biological applications and has a low cost, biocompatibility, biodegradability, and ease of chemical derivatization. Alginate is a “Generally Recognized As Safe” (GRAS) substance, as defined by the United States Food and Drug Administration, and is isolated from brown algae. Alginate has ability to develop crosslinking with Ca²⁺ to form strong gels. In some embodiments, a germplasm growth inducing composition can be formed by dispersing a mixture of a biodegradable polymer and a plant bioactive component in a sodium alginate solution, dipping seeds or other germplasms into the mixture, and applying a CaCl₂) solution to form a strong gel integument on the outer surface of the seed or germplasm. Alternatively the mixture can be sprayed onto the germplasm, followed by spraying the CaCl₂) solution. The concentrations of sodium alginate and CaCl₂) can vary from 1-90%, 1-75%, 1-50%, 1-40%, 1-30%, 1-20%, 1-15%, 1-14%, 1-13%, 1-12%, 1-11%, 1-10%, 1-9%, 1-8%, 1-7%, 1-6%, 1-5%, 1-4%, 1-3%, 10%, 9%, 8%, 7%, 6%, 5%, 4%, 3%, 2%, or 1%. Moreover, different calcium salts including but not limited to calcium chloride and calcium carbonate can be used in the formulation.

Cellulose derivatives such as methylcellulose can be used as a binder in some instances, and a biodegradable polymer described herein can be dispersed in a methylcellulose solution. The methylcellulose viscosity and concentration can vary depending on the target solubility of the coating. The obtained mixture can be coated on seed and dried into a coating. The coating can be formed out by combining the methylcellulose, biodegradable polymer, and plant bioactive component into an industrial seed treater, that includes seed or other germplasm, and after the drying process the coated seeds or germplasm can be removed and packaged for distribution. Alternatively the methylcellulose, biodegradable polymer, and plant bioactive component can be combined in a solution and sprayed on the seed or germplasm and then dried to give an integument film.

### II. Methods

In another aspect, a method of inducing germplasm growth comprises applying a composition described in Section I to a plant germplasm as an integument. The composition can, as described in Section I, be applied by dip coating a germplasm in the composition, spray coating the composition on the germplasm, or any other application method not inconsistent with the objectives of this disclosure.

A method described herein can further comprise in some embodiments, releasing the plant bioactive component described herein from the composition, wherein releasing the plant bioactive component increases germplasm growth. As described in Section I, the plant bioactive component can be released from the composition as the biodegradable polymeric material degrades. In some embodiments, the plant bioactive component can be released from the composition over a period of 1, 3, 5, 7, 10, 13, 15, 17, 20, 23, 25, 27, 30, 33, 35, 37, 40, 43, 45, 47, 50, 60, 70, 80, 90, 100, 150, 300, 600, 1 to 600, 5 to 600, 10 to 600, 20 to 600, 30 to 600, 40 to 600, 50 to 600, 60 to 600, 70 to 600, 80 to 600 90 to 600, 100 to 600, 200 to 600, 300 to 600, 400 to 600, 1 to 500, 1 to 400, 1 to 300, 1 to 200, 1 to 100, 1 to 75, 1 to 50, 1 to 40, 1 to 35, 1 to 30, 1 to 25, 1 to 20, 1 to 15, 1 to 10, 1 to 9, 1 to 7, 1 to 5, or 1 to 3 days in agricultural conditions.

In some embodiments, a method of inducing germplasm growth comprises combining a composition of Section I with an ammonium phosphate fertilizer to form a combination; and applying the combination to soil comprising a germplasm, or, in some instances directly to the germplasm itself. The method can further comprise releasing the plant bioactive component from the combination, wherein releasing the plant bioactive component increases germplasm growth.

In another aspect, a method of inducing germplasm growth comprises applying a composition described in Section I to soil comprising a germplasm, wherein the plant bioactive material comprises an ammonium phosphate fertilizer described herein. The method can further comprises releasing the ammonium phosphate fertilizer from the composition, wherein releasing the fertilizers increases germplasm grown. Release of the fertilizer can occur as the biodegradable polymeric material degrades over time.

In an embodiment, a method for increasing the efficiency of a liquid fertilizer comprises mixing the liquid fertilizer with a germplasm growth inducing composition in a ratio ranging from 10:1 to 10,000:1, wherein the ratio is based on the weight of the fertilizer's elemental phosphorus content and the germplasm effecting composition is comprised of repeating citric acid monomers of a molecular weight greater than 380 g/mol.

In another embodiment, a method for increasing the efficiency of a granular fertilizer comprises mixing the granular fertilizer with a germplasm growth inducing composition in a ratio ranging from 10:1 to 10,000:1, wherein the ratio is based on the weight of the fertilizer's elemental phosphorus content and the germplasm effecting composition is comprised of repeating citric acid monomers of a molecular weight greater than 380 g/mol.

In some embodiments, a method for increasing the efficiency of an ammoniated phosphate fertilizer comprises mixing the ammoniated phosphate with a germplasm growth inducing composition in a ratio ranging from 10:1 to 10,000:1, wherein the ratio is based on the weight of the fertilizer's elemental phosphorus content and the germplasm effecting composition is comprised of repeating tricarboxylic acid monomers of a molecular weight greater than 380 g/mol.

### III. Exemplary Applicants for Germplasm Growth Inducing Compositions

Components of a germplasm growth inducing composition (“composition”) and methods described herein can be used in different combinations and concentrations depending on the type of germplasm, method of application, and other factors. For each of the following exemplary applications for the compositions and methods, it should be appreciated that each is for the purpose of illustrating aspects of the invention, and does not limit the scope of the invention as defined in the claims.

In one example, a composition is comprised of citrate polymer comprising citric acid and 2,3-butanediol, the 2,3 butanediol being a covalently bound monomer in the citrate polymer, and, upon degradation of the citrate polymer, being a plant bioactive component. This composition can coat a soybean germplasm with a film equivalent to 1-10%, 3%, 5%, 8%, or 10% of the soybean germplasm's weight, biodegrade over less than 50 days, and increase the amount of available, solubilized phosphate in the soil.

In another example, a composition is comprised of a citrate polymer doped with a polyurethane and gibberellic acid as a plant bioactive component. The composition coats a corn germplasm with a film equivalent of 1-15%, 5-12%, 2%, 4%, 7%, 10%, 12% or 15% of the corn germplasm's weight, biodegrades over less than 100 days, and increases the root mass of the plant.

In an example, a composition is comprised of a citrate polymer and auxin, coats a cotton germplasm with a film equivalent to 10-30%, 15-25%, 10%, 15%, 20%, 25% or 30% of the germplasms weight, biodegrades over less than 10 days, and increases the rate at which the plant matures.

In another embodiment, a composition is comprised of a citrate polymer doped with a polyurethane and abscisic acid as a plant bioactive component. The composition is provided as a soil amendment on a wheat field, biodegrades over less than 150 days, and increases the wheat's resistance to water stress.

In one example, a composition is comprised of a citrate polymer doped with a polyurethane and cytokinin as a plant bioactive component. The composition is provided as a foliar spray on a vegetable crop, biodegrades over less than 5 days, and promotes the growth of lateral buds.

In another example, a composition is comprised of a citrate-based polymeric material that applied as an in-furrow amendment and increases the diversity of microbes in the soil upon biodegradation of the citrate-based polymeric material.

In an example, a composition is comprised of a citrate polymer doped with a polyurethane and strigalactone as a plant bioactive component. The composition can be applied as a soil amendment and increases a mass of arbuscular mycorrhiza.

In another example, a composition is comprised of a citrate polymer doped with a polyurethane and encapsulates 10⁶ CFU Rhizobia. The composition is applied to soil as pellets, and releases the Rhizobia colony in less than 100 days after planting as the citrate polymer biodegrades.

In yet another example, a composition is comprised of a citrate polymer doped with a polyurethane and an interfering RNA as a plant bioactive component. The composition coats a germplasm, and the encapsulated interfering RNA is released over a period of less than 100 days, and acts as a nematicide.

### Example 1

### Citrate Polymer Preparation

Citrate polymers can be made by reacting citric acid with one or more of other monomers, such as those previously described herein. In this EXAMPLE, an exemplary citrate polymer for germplasm coating was prepared in a single polycondensation reaction. Briefly, a citrate based polymer was synthesized by reacting L-serine (20 mmol), 2R,3R-butanediol (100 mmol), and citric acid (100 mmol) at 140° C. under constant stirring for 75 min. In this instance, 2R,3R-butanediol was selected because of its plant abiotic stress promoting capabilities as a microbial volatile organic compound (MVOC).

### Example 2

### Phosphate Solubilization by a Germplasm Growth Inducing Composition

In this EXAMPLE, a citrate polymer was prepared according to EXAMPLE 1, and subsequently combined with an integument and a plant bioactive component to form a germplasm growth inducing composition. In this EXAMPLE, the integument was alginate and the plant bioactive component was calcium hydrogen phosphate (CaHPO₄).

The citrate polymer (0.003 g, 0.03 g, and 0.06 g) and alginate coatings with citrate polymer, which included 0.003 g, 0.03 g, and 0.06 g of citrate polymers in 0.03 g, 0.2 g, and 0.4 g of total integument material, respectively, were incubated in 10 mL of sterile 10 g/L CaHPO₄ solution at room temperature. CaHPO₄ was used as an insoluble phosphate source. The incubation was conducted at room temperature for 50 days. As negative control, the insoluble phosphate solution was also incubated by itself. Moreover, alginate without citrate polymer was also incubated in the insoluble phosphate solution to see the effect of alginate coating on phosphate solubilization. As a positive control, citric acid solutions at different concentrations (0-60 mM) were prepared and solubilization of phosphate by standard citric acid solution at different concentrations was monitored. To determine phosphate solubilization, 500 μL of sample was taken and centrifuged to remove the insoluble phosphate. The supernatant was analyzed to determine the solubilized phosphate concentration with a colorimetric phosphate assay kit (Biovision Inc., Milpitas, Ca).

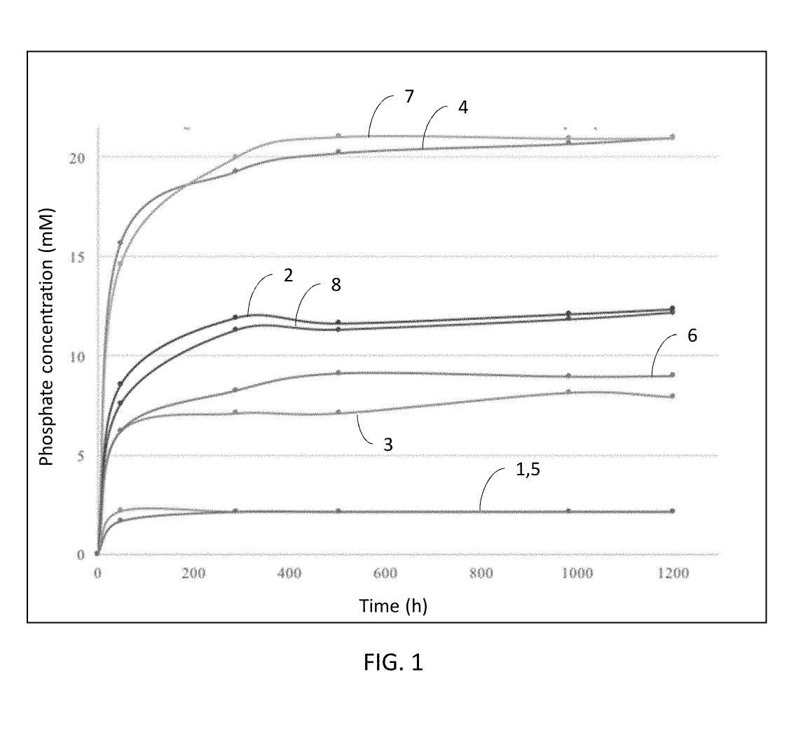

The solubilized phosphate concentrations by the polymer and coating materials are given in FIG. 1. In FIG. 1, alginate is shown as element 1, citrate polymer (0.03 g) as element 2, alginate/citrate polymer (0.003 g) as element 3, alginate/citrate polymer 0.06 g) as element 4, insoluble CaHPO₄ as element 5, citrate polymer (0.003 g) as element 6, citrate polymer (0.06 g) as element 7, and alginate/citrate polymer (0.03 g) as element 8.

As shown, in 48 h, 0.06 g, 0.03 g, and 0.003 g of citrate based polymer solubilized 14.58 mM, 7.61 mM, 6.19 mM CaHPO4, respectively. In 288 h, the soluble phosphate concentrations increased to 19.98 mM, 11.89 mM, and 8.23 mM by the presence of 0.06 g, 0.03 g, and 0.003 g of citrate based polymer. The phosphate solubilization by alginate/citrate polymer integument showed similar trends and similar amounts of phosphate solubilization as the citrate based polymer. The difference between phosphate solubilization amounts by citrate based polymer and alginate/citrate polymer integument was insignificant (p≥0.05). The alginate coating itself did not appear to contribute to phosphate solubilization.

### Example 3

### Phosphate Solubilization in Sandy Soil Using a Germplasm Growth Inducing Composition

Phosphate solubilization by alginate/citrate polymer material having 0.003 g, 0.03 g, and 0.06 g of citrate polymer in 0.03 g, 0.2 g, 0.4 g of total coating material, respectively, was monitored in 30 g of sterile sand containing 10% (w/w) 10 g/L CaHPO₄ solution. Sterile plastic beads were coated with alginate/citrate polymer coating material. The coated beads were placed in 2 cm depth in sand with 10% (w/w sand) 10 g/L CaHPO₄. The sand samples with coated beads were incubated at room temperature for 54 days. As negative control, the sand sample without coating material was also incubated. To determine the phosphate solubilization amount in sand, the coated bead was removed from the sand and 7 ml of deionized (“DI”) water was added onto the sand sample and mixed at 100 rpm for 30 min. Then the sample was centrifuged and the supernatant used to determine the phosphate solubilization by colorimetric phosphate assay kit (Biovision Inc., Milpitas, Ca).

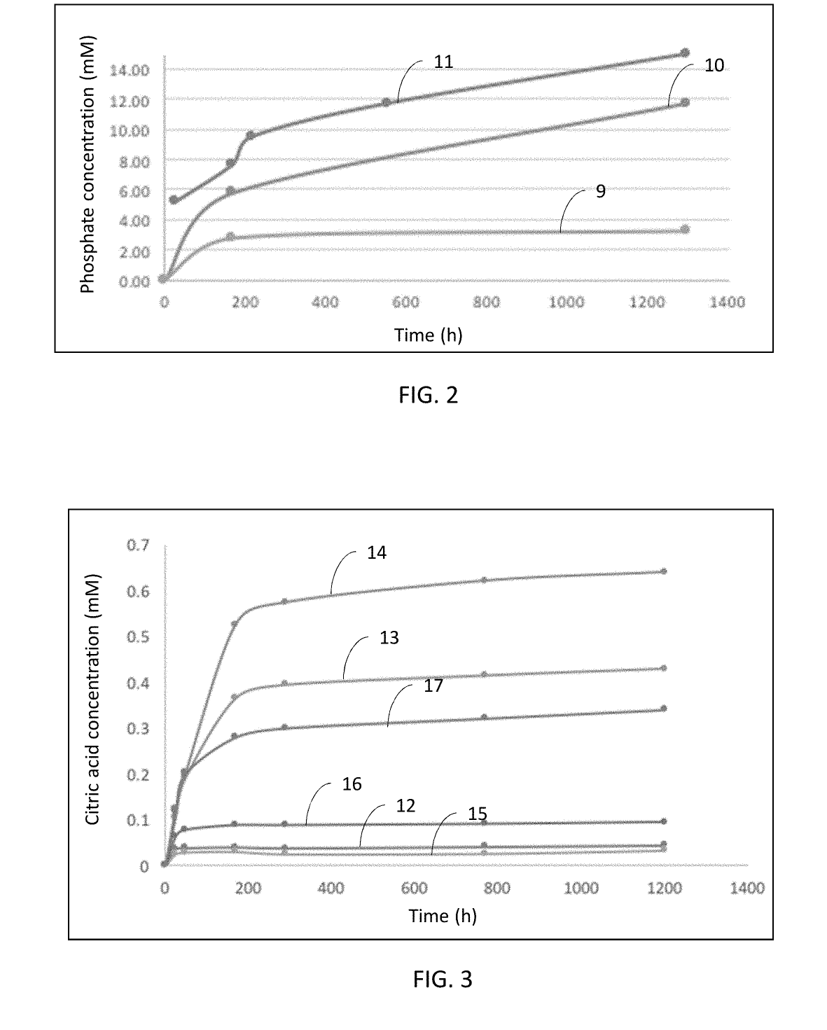

In FIG. 2, alginate/citrate polymer (0.003 g) is shown as element 9, alginate/citrate polymer (0.03 g) as element 10, and alginate/citrate polymer (0.06 g) as element 11. the citrate polymer amount increased, the phosphate solubilization increased (p<0.05). In 7 days, the phosphate solubilization concentrations in sand by alginate/citrate polymer integument with 0.06 g, 0.03 g, and 0.003 g citrate polymer were 7.66 mM, 5.75 mM, and 2.72 mM, respectively. At the end of 54 days, the soluble phosphate concentration increased to 14.98 mM, 11.71 mM, and 3.19 mM by the presence of integument that included 0.06 g, 0.03 g, and 0.003 g citrate polymer, respectively.

### Example 4

### Citrate Release by Polymer Degradation Over a Period of Time

In this EXAMPLE, release of citrate from the germplasm growth inducing composition prepared in EXAMPLE 2 into surrounding media as a result of citrate polymer degradation was explored, as well as the solubilization effects the released citrate had on CaHPO₄. It was believed that the released free citrate would interact with the CaHPO₄ present and cause solubilization of the phosphate. As illustrated in FIG. 3, degradation of the citrate polymer released citrate, and the release citrate binds calcium in CaHPO₄, and solubilizes the bound phosphate.

A citrate polymer (0.003 g, 0.03 g, and 0.06 g) and alginate/citrate polymer coating material, which included the same amounts of citrate polymer (0.003, 0.03, and 0.06 g of citrate polymer in 0.03, 0.2 g, 0.4 g total coating material, respectively) were incubated in 10 mL of sterile DI water in falcon tube. The incubation was conducted at room temperature for 54 days. To determine the released citrate concentration, 500 μL of sample was taken from falcon tube and centrifuged. The supernatant was analyzed with a citrate assay kit (Biovision Inc., Milpitas, Ca).

In FIG. 3, citrate polymer (0.003 g)) is represented as element 12, citrate polymer (0.03 g) as element 13, citrate polymer (0.06 g) as element 14, alginate/citrate polymer (0.003 g) as element 15, alginate/citrate polymer (0.03 g) as element 16, and alginate/citrate polymer (0.06 g) as element 17. It was observed that at the end of 288 h, as a result of citrate release from the polymers at the amounts of 0.06 g, 0.03 g, 0.003 g, the citrate concentrations in DI water were 0.57 mM, 0.39 mM, and 0.038 mM, respectively. In comparison, the citrate based polymer alginate integument that included 0.06 g, 0.03 g, and 0.003 g of citrate polymer increased the citrate concentration of DI water to 0.30 mM, 0.088 mM, and 0.024 mM in 288 h.

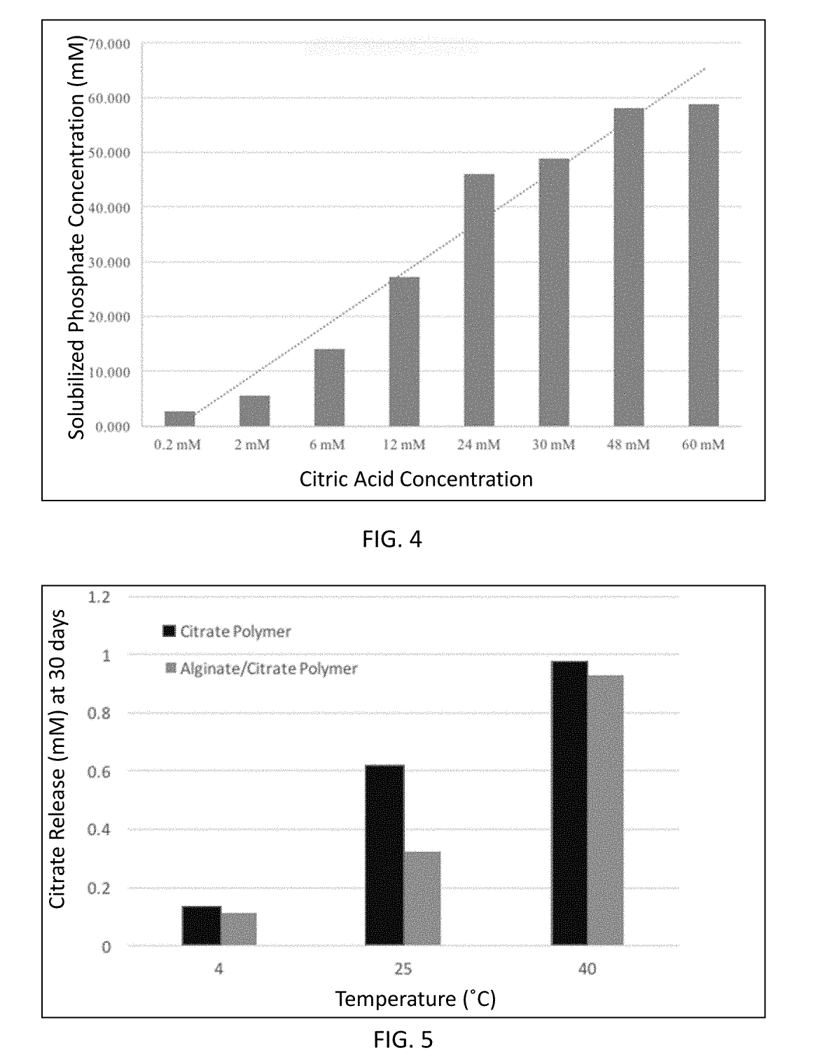

The phosphate solubilization with standard citrate solution at different concentrations (0-60 mM) was also observed (FIG. 4). 10 g/L of insoluble phosphate became soluble in the presence of 48 mM of citrate. While 14 mM phosphate became soluble in the presence of 6 mM standard citrate solution, the citrate based polymer solubilized 14.58 mM phosphate in the presence of 0.57 mM citrate released from the 0.06 g polymer in 288 h. Moreover, while 5.48 mM phosphate solubilized in the presence of 2 mM standard citrate solution, 0.003 g polymer with only 0.038 mM citrate release provided 8.23 mM phosphate solubilization.

Consequently, in addition to released citrate from the citrate polymer, the citrate polymer itself can also bind calcium and solubilize bound phosphate in CaHPO₄.

### Example 5

### Effect of Temperature and Initial pH on Polymer Degradation

A citrate polymer (0.06 g) prepared according to EXAMPLE 1 and an alginate/citrate polymer integument prepared according to EXAMPLE 2, which included the same amounts of citrate polymer (0.06 g), were incubated at different temperatures (4° C., 25° C., and 40° C.) in 10 mL DI water to see the effect of temperature on polymer degradation. The supernatant after 30 hours of incubation was analyzed for determining citrate concentration in DI water. It was observed that increase in the temperature significantly increased the citrate release from the citrate polymer and alginate/citrate polymer coating (p<0.05), as illustrated in FIG. 5.

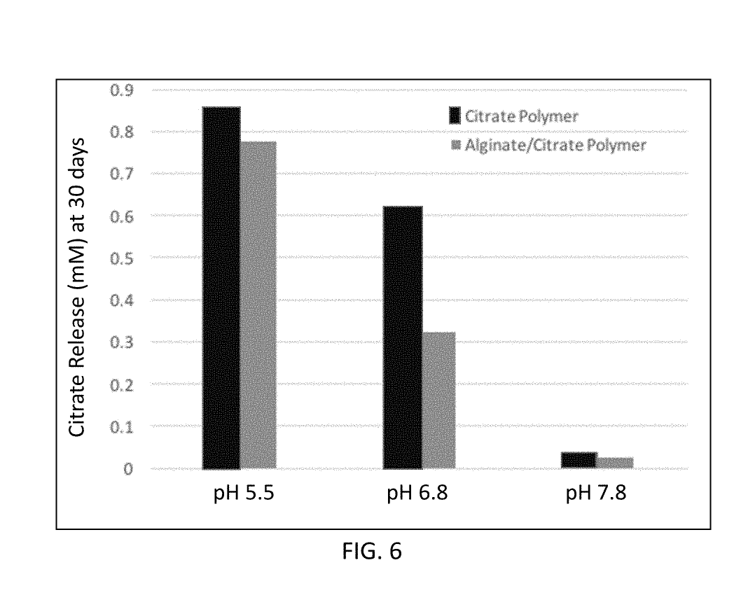

In North America, the pH of the soil varies between 5.7 to 7.7. Citrate release from the citrate polymer and alginate/citrate polymer integument were monitored under different initial pH values (pH 5.5, 6.8, and 7.8) to reflect the range of different soil pH. The citrate polymer (0.06 g) and the alginate/citrate polymer coating material, which included the same amounts of citrate polymer (0.06 g), were incubated in 10 mL DI water at different pH values (5.5, 6.7, 7.7). The pH of the DI water was adjusted to pH 5.5 with 0.1 m HCl and to pH 7.8 with 0.1 M NaOH to see the effect of initial pH on polymer degradation. The supernatant after 30 hours of incubation was analyzed for determining citrate concentration in DI water. The changes in the initial pH significantly affected citrate release from citrate polymer (0.06 g) and from the alginate/citrate polymer coating material with 0.06 g citrate polymer (p<0.05), as shown in FIG. 6.

### Example 6

### Effect of Citrate Based Polymer on Plant Growth

Soybean seeds (Glycine max (L.) Merr., PI 548555) were obtained from U.S. National Plant Germplasm System. The seed sterilization was performed as follows; the seed was first wetted in 20.0 M ethanol (95%) for 5 sec, then soaked in 0.21 M NaOCl for 5 min. After surface-sterilization with ethanol and NaOCl, the seeds were washed once in sterile distilled water, soaked for 10 min in 0.01 M HCl to remove traces of NaOCl, then washed five times in sterile distilled water to remove traces of HCl.

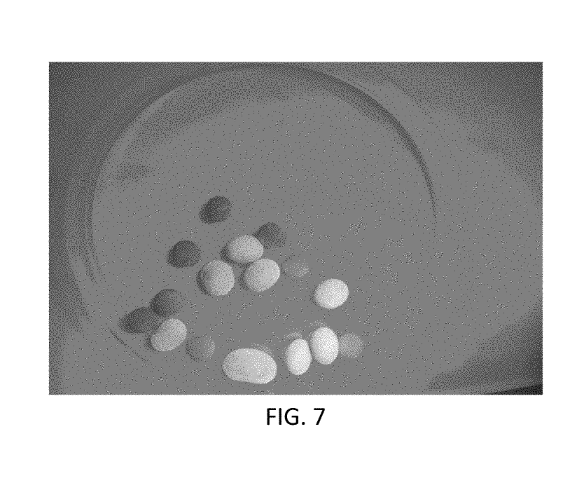

The seeds were then each coated with 0.003 g of citrate polymer or 0.03 g of total alginate/citrate polymer integument, which contained 0.003 g of citrate polymer content. For the growth chamber study, Magenta™ GA-7 plant culture boxes (3×3×4″) were filled with 300 g of autoclaved washed quartz sand containing 10% (w/w) modified ¼-strength Hoagland nutrient solution (Accinelli et al. Crop Protection, 89: 123-128 (2016) which is incorporated by reference in its entirety). 1.5 mM CaHPO₄ was used as insoluble phosphate source in modified ¼-strength Hoagland nutrient solution. FIG. 7 shows a picture of soybean seeds coated in a germplasm growth inducing composition (white) and control soybean seeds that are uncoated (dark) under fluorescent lighting.

The coated seeds and uncoated control seeds were sown in the boxes. The boxes were planted with seeds to a depth of 2 cm, and maintained in a growth chamber for about 21 days until V1 stage under supplemental light for a 12-h period. The day and night temperatures were set to 28° C. and 15° C., respectively. The boxes were weighed every day, ¼ strength Hoagland's solution with insoluble phosphate were added to the boxes to the same weight to restore the moisture levels. A total of 10 seeds were planted for each sample type.

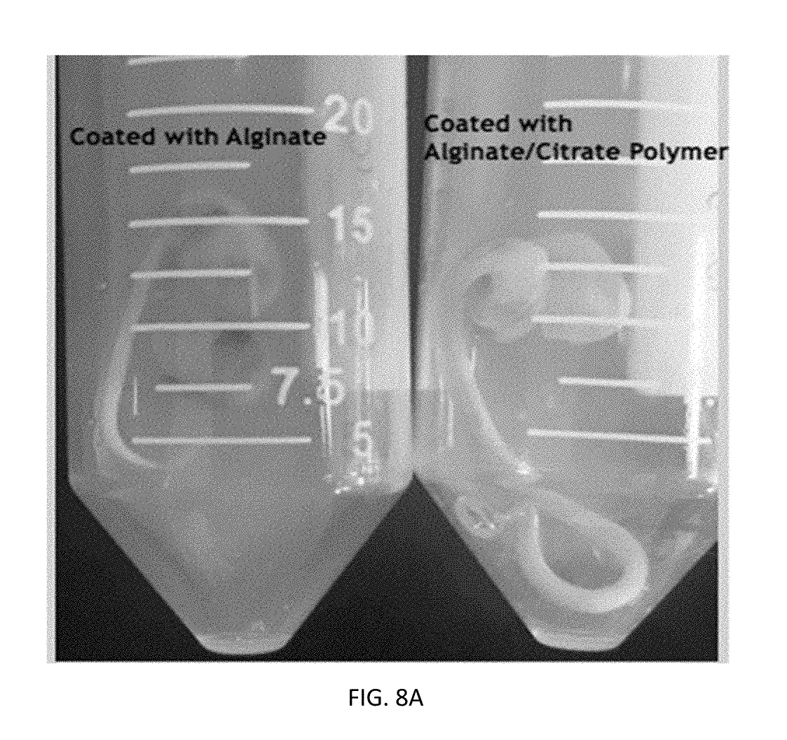

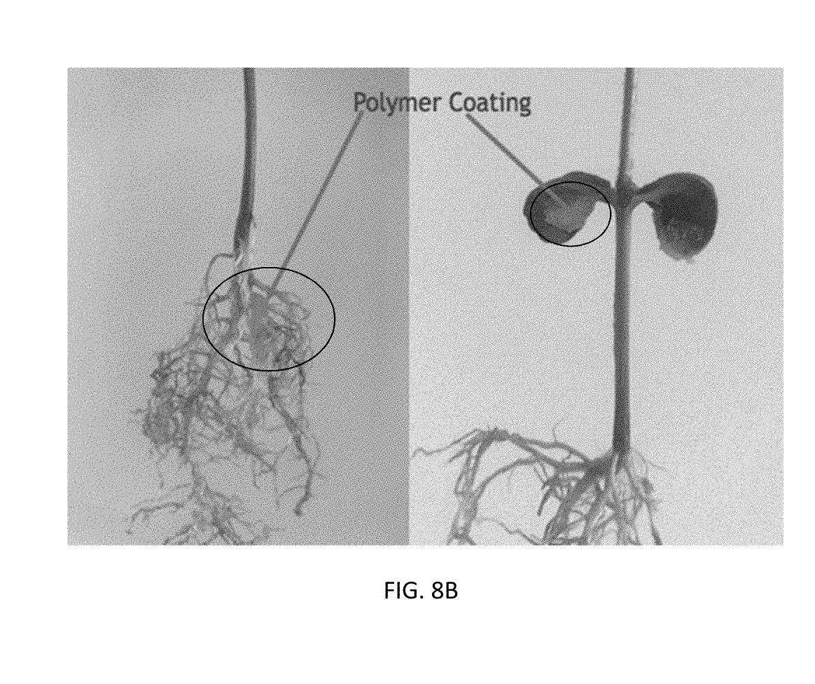

A seed with at least 1 mm of protruded radicle was scored as germinated. The germination power was calculated as the final percentage of germinated seeds for uncoated and coated seeds with 0.06 g, 0.03 g, and 0.003 g polymer. The germination power of coated seed with 0.03 g alginate/citrate polymer integument with 0.003 g of citrate polymer was found as 80%. The integument material was observed to remain fixed on the root as seen in FIG. 8B. Therefore, the integument was able to provide phosphate solubilization during plant growth. Similar germination power was observed for uncoated seeds.

The plants were harvested at V1 stage and they were separated into leaf trifoliate, stems with petioles, and roots. Plant height, fresh weight of each part of the plant were determined. Plant parts were dried at 70° C. for 72 h and weighed to determine the dry weight of the plant. The uncoated seeds and the alginate/citrate polymer coated seeds, which included 0.003 g of citrate polymer, were planted and harvested at V1 stage. The sand was supplemented with the ¼ strength Hoagland solution with insoluble phosphate. It was observed that the plant height and the weight for the coated seeds were slightly higher than the plants that were grown from the uncoated seeds, as shown in Table 1.

TABLE 1
Plant height and weight of the plants at V1 stage.

| | Plant Height | Fresh Plant Weight |
|---|---|---|
| Control | 26.50 ± 2.17 | 2.27 ± 0.71 |
| Alginate/Citrate polymer coated seed | 29.50 ± 0.02 | 2.69 ± 0.76 |

The roots and trifoliate leaves were scanned for each sample that was harvested at V1 stage. The leaf area values were determined using ImageJ software after setting the scale. The root architecture parameters were evaluated by the SmartRoot freeware (Universite Catholique de Louvain, Belgium, Lobet et al. 2011) based on ImageJ software (Rattanapichai and Klem, 2016).

The trifoliate leaf areas were slightly higher for the polymer coated seeds than the control (uncoated seed), as shown in Table 2.

TABLE 2
Trifoliate leaf areas of the plants at V1 stage.

| | Trifoliate Leaf Area | | |
|---|---|---|---|
| Control | 15.67 ± 2.15 | 11.44 ± 0.81 | 11.27 ± 1.99 |
| Alginate/Citrate polymer | 15.47 ± 1.89 | 13.66 ± 2.03 | 13.12 ± 0.02 |
| coated seed | | | |

Table 3 shows that although plant height became more for the coated seeds, the difference between root heights of the plants grown from coated and uncoated seeds was not significant (p≥0.05). The lateral root density and number of lateral roots were slightly higher for the coated seeds than uncoated seeds.

TABLE 3
Root properties of plants at V1 stage.

| | | Alginate/Citrate polymer coated |
|---|---|---|
| | Control | seed |
| Root height | 8.89 ± 2.27 | 9.09 ± 1.29 |
| Root mean diameter | 0.14 ± 0.01 | 0.15 ± 0.04 |
| Number of laterals | 32.33 ± 10.50 | 38.50 ± 10.61 |
| Lateral density | 4.38 ± 1.18 | 5.12 ± 1.06 |
| (root/cm) | | |

Trifoliate leaf extracts were made by macerating leaf sections in 96% ethanol at 4° C. overnight in complete darkness to avoid formation of breakdown products. The chlorophyll contents were determined by the methods described by Martinez, Annals of Applied Biology, 123: 673-684 (1993) and Warren, Journal of Plant Nutrition 31(7): 1321-1332 (2008), both of which are incorporated by reference in their entirety.

It has been reported that phosphorous deficiency has little effect on photosynthetic activity. In this study, in the presence of insoluble phosphate it was observed that both chlorophyll a and b increased slightly increased when the seeds were coated with alginate/citrate polymer that included 0.003 g of citrate polymer (Table 4). The reason for the increase in chlorophyll content can be correlated with the increase in the availability of phosphate by the presence of the citrate based polymer. Table 5 shows that inorganic phosphate uptake by the coated seed was significantly higher than the uncoated seed (p<0.05).

TABLE 4
Chlorophyll a and Chlorophyll b contents of plants at V1 stage.

| | Chlorophyll a | Chlorophyll b |
|---|---|---|
| Control | 16.26 ± 1.75 | 3.53 ± 0.36 |
| Alginate/Citrate polymer coated seed | 18.86 ± 2.17 | 4.14 ± 0.43 |

Then, the inorganic phosphate uptake by plants was determined by the method described by Bertramson, Plant Physiology, 17(3), 447-454 (1942), which is incorporated by reference its entirety. The phosphate concentration was expressed as the mmol phosphate per gram dry weight of the plant. Table 5 shows that inorganic phosphate uptake by the coated seed was significantly higher than the uncoated seed (p<0.05).

TABLE 5
Inorganic phosphate uptake amount by plants at V1 stage.

| | Inorganic Phosphate Uptake by Plant |
|---|---|
| | (mmol/g dry weight of plant) |
| Control | 0.04 ± 0.01 |
| Alginate/Citrate polymer coated | 0.19 ± 0.02 |
| seed | |

### Example 7

### Effect of Methylcellulose Integument Matrix on Phosphate Solubilization

Citrate polymer was combined with 2% 15 centipoise (cPs) and also 4000 cPs methylcellulose and the sterile plastic beads were coated with this mixture. The total integument contained 0.06 g of citrate based polymer. The coated beads were incubated in 10 mL of sterile 10 g/L CaHPO₄ solution at room temperature. To determine the phosphate solubilization, 500 μL of sample was taken and centrifuged to remove the insoluble phosphate. The supernatant was analyzed to determine the solubilized phosphate concentration with a colorimetric phosphate assay kit (Biovision Inc., Milpitas, Ca).

It was observed that in 24 h, the methylcellulose dispersed in water and released the citrate polymer, unlike alginate integument matrix. The solubilized phosphate concentration was found as 24.19 mM for the integument that contains citrate polymer and 15 cPs methylcellulose. This phosphate solubilization rate was significantly higher than the phosphate solubilization by the citrate polymer integument with 4000 cPs methylcellulose (p<0.05). The phosphate solubilization amount with 4000 cPs methylcellulose/citrate polymer integument was found as 8.64 mM, which was not significantly different than the phosphate solubilization by citrate polymer itself and alginate/citrate polymer integument (p≥0.05).

1. A germplasm growth inducing composition, comprising:
a biodegradable polymer or oligomer; and
a plant bioactive component.

2. The composition of claim 1, wherein the biodegradable polymer is formed from one or more monomers selected from a group consisting of citric acid, butanediol, octanediol, oxalic acid, lactic acid, pentadecane, ammonia, 3-hexanone, isophorone diisocyanate, 1-hexanol, tridecanal, 1-octen-3-ol, acetaldehyde, butanoic acid, gallic acid, butanoic acid, indole acetic acid, furfural, propanoic acid, glycolic acid, tartaric acid, malic acid, mandelic acid, tannic acid, isocitric acid, aconitic acid, propane-1,2,3-tricarboxylic acid, trimesic acid or any derivative thereof.

3. The composition of claim 1, wherein the biodegradable polymer comprises a citrate polymer.

4. The composition of claim 3, wherein the citrate polymer is formed from one or more monomers of citric acid and one or more monomers selected from a group consisting of a C2-C14 alcohol, a C2-C14 diol, an isocyanate, glycerol, a polyol, oxalic acid, lactic acid, 1-octen-3-ol, butanoic acid, butanoic acid, indole acetic acid, furfural, propanoic acid, glycolic acid, tartaric acid, malic acid, maleic anhydride, mandelic acid, N-methyldiethanol amine (MDEA), an amino acid, or any combination or derivative thereof.

5. The composition of claim 3, wherein the citrate polymer is formed from one or more monomers of citric acid, one or more monomers of a C2-C14 polyol, and one or more monomers of an amino acid.

6. The composition of claim 3, wherein the citrate polymer has a weight average molecular weight of 300 g/mol or greater.

7. The composition of claim 3, wherein the citrate polymer comprises a polyurethane.

8. The composition of claim 1, wherein the plant bioactive component comprises a phytohormone, a microbial volatile organic compound, a fertilizer, a plant growth-promoting microbe, a germplasm active compound, or any combination thereof.

9. The composition of claim 8, wherein the phytohormone comprises indole acetic acid, lipochitooligosaccharide, a flavonoids, a cytokinin including zeatin, a strigalactone, abscisic acid, a nodulation factor, salicylic acid, jasmonic acid, gibberellic acid, a brassinosteroid, a strigolactone, an auxin, ethylene, a polyamine, nitric oxide, a plant peptide hormone, a karrikin, triacontanol, or any combination or derivative thereof.

10. The composition of claim 8, wherein the microbial volatile organic compound comprises γ-patchoulene, 3-methyl butanol, 1-octen 3-ol, 2-undecanone, 3-methylbutanoate, 2-methylbutan-1-ol, 4-methyl-2-heptanone, ethanethioic acid, 2-methyl propanal, ethenyl acetate, 3-methyl 2-pentanoene, methyl 2-methylbutanoate, methyl 3-methylbutanoate, 4-methyl 3-penten-2-one, 3-methyl 2-heptanone, myrcene, terpinene, methyl salicylate, 2-pentadecanone, 1H-pyrrole, ethyl butanoate, chlorobenzene, dimethylsulfone, 2-octanone, 5-dodecanone, 3-methyl-2-pentanone, geosmin, 1-pentanol, 2-methyl-1-propanol, dimethyl 2-octanol, disulfide, acetophenone, 2-isobutyl-3-methoxypyrazine, 2-heptanone, 5-methyl-3-heptanone, 2-methyl-2-butanol, 2-pentanol, 3-octanol, ethanol, anisole, 2-isopropyl-3-methoxypyrazine, hexanol, 2-methylfuran, 3-methyl-1-butanol, 2-pentanone, 3-octanone, 2-ethyl-1-hexanol, 1-butanol, isopropanol, 2-hexanone, 3-methylfuran, 3-methyl-2-butanol, 2-pentylfuran, 1-octen-3-ol, 2-ethylfuran, 2-butanone, isopropyl, 3-hexanone, acetate, isobutyrate, 2-methylisoborneol, isovaleraldehyde, a-terpineol, 2-nonanone, ethylfuran, 2r,3r-butanediol, 2-methyl-1-butanol, citric acid, 1-octanol, a Nod factor, lipochitooligosaccharide, a flavonoid, a strigalactone, or any combination or derivative thereof.

11. The composition of claim 8, wherein the fertilizer comprises a nitrate, potassium, a phosphorous, a phosphate, ammonia, ferric oxide, zinc oxide, an iron chelate, copper oxide, or any combination or derivative thereof.

12. The composition of claim 8, wherein the plant growth-promoting microbe comprises Rhizobia, Trichoderma, Streptomyces, Pseudomonas, Glomus, Arbuscular mycorrhiza fungi, Bacillus, Actinomyces, Penicillium, or any combination thereof.

13. The composition of claim 8, wherein the germplasm active compound comprises azoxystrobin, boscalid, carbendazim (MBC), chlorothalonil, cyprodinil, dicloran, fenbuconazole, fludioxonil, metalaxyl, myclobutanil, pyraclostrobin, tebuconazole, thiabendazole, trifloxystrobin, thpi, vinclozolin, pesticides, aldicarb sulfoxide, bifenthrin, chlorpyrifos, coumaphos, a ribonucleic acid sequence, deoxyribonucleic acid sequence, a viral vector, an amino acid, an antibody, an herbicide, a fungicide, atrazine, fluridone, metolachlor, oxyfluorfen, pendimethalin, propazine, tebuthiuron, trifluralin, 2,4 dimethylphenyl formamide (DMPF), acephate, acetamiprid, aldicarb sulfone, citric acid, or any combination or derivative thereof.

14. The composition of claim 1, wherein the biodegradable polymer comprises a citrate polymer and the plant bioactive component comprises an ammonium phosphate.

15. The composition of claim 14, wherein the citrate polymer has a weight average molecular weight of 300 g/mol or greater, and a ratio of citrate polymer to ammonium phosphate is between 10:1 to 10,000:1 based on a weight of the elemental phosphorous content.

16. The composition of claim 1, further comprising an integument or soil amendment comprising an alginate, polyethylene glycol, peat, pullulan, methyl cellulose, chitosan, polyvinylpyrolidone, starch, or any combination or derivative thereof.

17. A method of inducing germplasm growth, comprising:
applying the composition of claim 1 to a plant germplasm as an integument.

18. The method of claim 17, further comprising releasing the plant bioactive component from the composition, wherein releasing the plant bioactive component increases germplasm growth.

19. A method of inducing germplasm growth, comprising:
applying the composition of claim 1 to soil comprising a germplasm, wherein the plant bioactive material comprises a phosphate-containing fertilizer.

20. The method of claim 19, further comprising releasing the phosphate-containing fertilizer from the composition, wherein releasing the fertilizers increases germplasm grown.
